(19) United States
(12) Patent Application Publication
(10) Pub. No.: US 2006/0154215 A1
(43) Pub. Date: Jul. 13, 2006

(54) Toy for teaching colors

(76) Inventor: Kay E. Feeman, Aurora, CO (US)

Correspondence Address: LITMAN LAW OFFICES, LTD, PO BOX 15035, CRYSTAL CITY STATION, ARLINGTON, VA, 22215, US

(21) Appl. No.: 11/030,048

(22) Filed: Jan. 7, 2005

(51) Int. Cl. G09B 11/10

(52) U.S. Cl. 434/84

(57) ABSTRACT

The toy for teaching colors is a series of three translucent discs or panels, with each disc or panel having a different additive or subtractive primary color. Each disc or panel includes a relatively thick rim adapted and configured to facilitate handling the devices, particularly by small children. The discs or panels may be provided in a variety of different regular and irregular shapes, as desired. Complementary engagement between individual units, e.g., mating depressions and protrusions, etc., may be provided. The toy is particularly valuable for teaching very young children the effects of combining different additive and subtractive colors to arrive at another color, and may have additional value in teaching that color is a superficial attribute of objects as well as people, and, thus, that people should not be judged by their external appearance or color.

### BACKGROUND OF THE INVENTION

1. Field of the Invention

The present invention relates generally to translucent optical color filters. More specifically, the present invention comprises a series of such translucent filters in various additive, subtractive, primary, or secondary colors, as desired, with the various filters each having a peripheral hand grip rim. The present filters are used as an educational toy for teaching very young children about various additive, subtractive, and complementary color combinations.

2. Description of the Related Art

Most people, including small children, do not understand the concepts relating to the various colors comprising the visual spectrum. While many people understand the technical aspects of color, i.e., color comprises various wavelengths of the visual electromagnetic spectrum ranging from shorter wavelengths at the blue end of the spectrum to longer wavelengths at the red end, they do not realize how these various colors may be combined with one another, with various wavelengths or frequencies supplementing and canceling one another to produce different colors.

Color theory is a reasonably well established, but not commonly known, field. Color theory deals with various additive and subtractive color combinations, as well as primary and secondary colors which complement or clash with one another.

Very little instruction is provided in most public and private education through the high school level, with detailed color theory generally being taught only at the collegiate level in certain art, optical, and photography fields.

As such, most people do not have a good understanding of the way various colors combine to affect the apparent color or tint of various objects. One potential reason for this is that there are few, if any, tools or devices for teaching and showing the effects of various color combinations when viewing various objects. The present inventor is aware of some devices of the related art which relate to colors in general, but none are really suitable for use in teaching basic color theory to very young children to provide them with a solid understanding of the basics at a very early age. This is a shame, because it is important that children be taught from a very early age that color is an external attribute of an object or person, and that an object or person may be made to appear to have innumerable different colors without changing the inherent characteristics of that object or person. In other words, a good foundation in color theory is not only educational, but may also plant at least the subconscious concept of racial harmony as well.

Japanese Patent Publication No. 7-184,215, published on Jul, 21, 1995, describes (according to the drawings and English abstract) a color separation filter having a single partially coated translucent disc, with the disc being coated in a different additive or subtractive color over different overlapping portions thereof on opposite sides thereof. The result is that only two colors need be applied to the disc due to the overlapping of the two colors over a portion of the disc, to produce the third additive or subtractive color desired. No series of separate, unbroken, manually manipulated discs each having its own uniform translucent color, is disclosed in the '215 Japanese Patent Publication.

Japanese Patent Publication No. 2000-338,426, published on Dec. 8, 2000, describes (according to the drawings and English abstract) a single disc formed of three arcuate disc segments assembled together, with each segment being a different color from the others. At least one transparent reinforcement disc is applied to the segmented color disc. Again, no series of separate, unbroken, differently colored, manually manipulated discs is disclosed in the '426 Japanese Patent Publication.

None of the above inventions and patents, taken either singly or in combination, is seen to describe the instant invention as claimed. Thus, a toy for teaching colors solving the aforementioned problems is desired.

### SUMMARY OF THE INVENTION

The toy for teaching colors comprises a series of three separate translucent discs or panels, each having a different color than the other two. Each disc or panel includes a relatively thick, smooth rim adapted and configured to serve as a handle for the device. Preferably, all of the discs or color panels of any given group are of the same size and shape. Complementary engagement means (e.g., depressions and protrusions, etc.) may be provided on opposite sides of the rim, to allow the discs or panels to be stacked securely and to facilitate holding two or more such discs together.

The present toy for teaching colors is particularly valuable and useful for teaching small children about basic color theory, i.e., the effects of combining two or more additive or subtractive colors to form a new color (or lack thereof). On a more subtle level, the present color teaching toy serves to show children that color is only a superficial aspect of the quality of an object or person and that the object or person per se is unchanged regardless of its color. Thus, the present toy for teaching colors may also be beneficial in instilling an appreciation for others, regardless of their race or color, as well as teaching the basic theory behind the visual spectrum.

These and other features of the present invention will become readily apparent upon further review of the following specification and drawings.

### BRIEF DESCRIPTION OF THE DRAWINGS

FIG. 1 is an environmental, perspective view of a series of toys for teaching colors according to the present invention, showing their operation and use.

FIG. 2 is an exploded perspective view in partial section of a series of additive color discs comprising an embodiment of the present toy for teaching colors, showing various details thereof.

FIG. 3 is an exploded perspective view in partial section of a series of subtractive color discs comprising another embodiment.

FIG. 4 is an exploded perspective view of yet another embodiment of the present invention, showing a pair of square or rectangular panels.

FIG. 5 is an exploded perspective view of still another embodiment, comprising triangular panels.

Similar reference characters denote corresponding features consistently throughout the attached drawings.

### DETAILED DESCRIPTION OF THE PREFERRED EMBODIMENTS

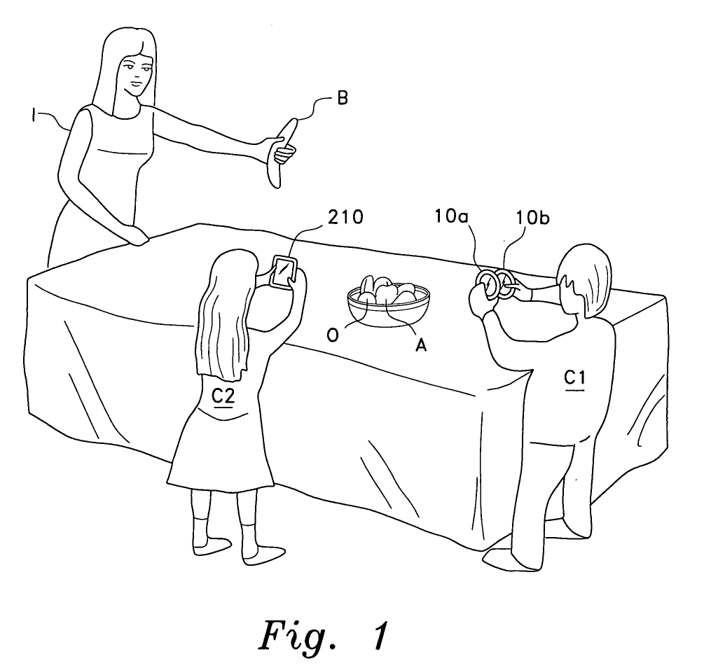

The present invention comprises various embodiments of a toy for teaching colors, intended primarily for use by very young children with supervision by an adult instructor or older child. The present toy essentially comprises a series of translucent panels, with each of the panels having a different additive or subtractive color from one another, and with each of the panels being surrounded by a relatively thick handling rim or frame preferably of circular cross section and of like color to the enclosed panel or sheet. FIG. 1 of the drawings provides an environmental illustration of the use of the present color teaching toy, with an instructor I displaying an object (e.g., a yellow banana B) for the children C1 and C2 to view using their color teaching toys 10a, 10b, and 200. The children may view the displayed object (or other object, as desired, e.g., a red apple A, an orange O, etc., as shown in the bowl in FIG. 1) through one or more of the translucent panels of the color teaching toy, to gain insight upon the effects which different additive and subtractive colors have upon the perceived color(s) of various object(s).

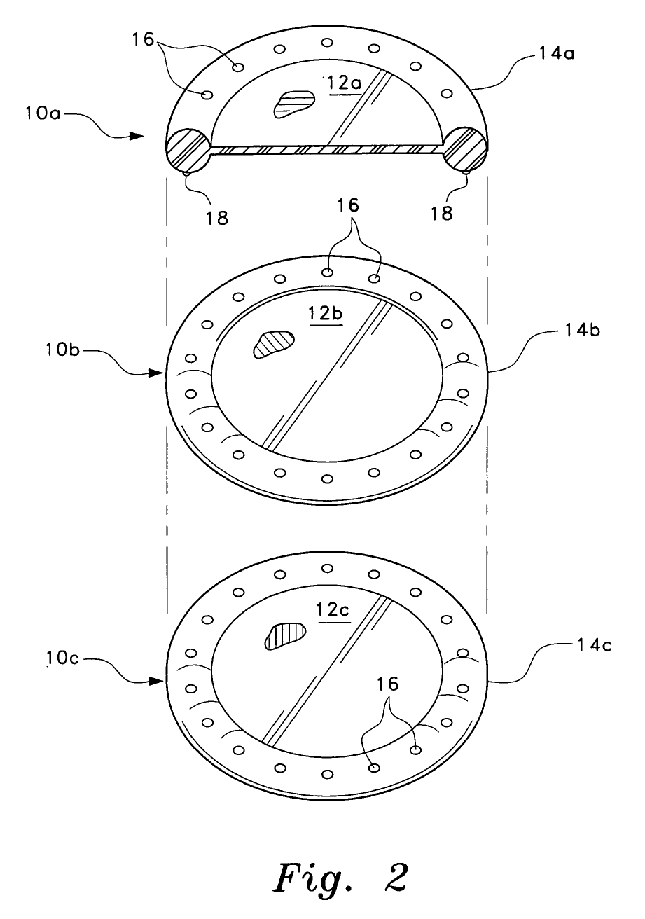

FIG. 2 provides a perspective illustration of a series of translucent panels or discs 10a, 10b, and 10c forming a first embodiment of the present color teaching toy 10. Each of the discs 10a through 10c comprises a relatively thin, flat, and unbroken central translucent sheet, respectively 12a through 12c, surrounded by a continuous, unbroken peripheral handling rim, respectively 14a through 14c. The central translucent sheets 12a through 12c and their rims 14a through 14c are preferably formed of a relatively stiff or rigid plastic material, and may have a thickness around one sixteenth to one eighth of an inch. Softer, more flexible materials having different thickness may be used as desired, but the preferred relatively hard material and thickness provides greater scratch and damage resistance and resistance to optical distortion.

The peripheral handling rims 14a through 14c may be formed homogeneously with their respective central sheets 12a through 12c as integral, monolithic units at the time of manufacture, e.g., by injection molding or other suitable process as desired. The rims 14a through 14c are thus each colored identically with their respective central sheets or panes 12a through 12c, enabling a person to see at a glance the color of the central pane of any given unit, even when the discs or panels are stacked atop one another. The handling rims 14a through 14c are preferably relatively thick in comparison to the thickness of the translucent central sheets or panes 12a through 12c, with the rims 14a through 14c preferably having a cross-sectional thickness on the order of one half inch, more or less. This thickness facilitates the handling of the devices by small children, who may not have developed the manual dexterity for manipulating smaller or finer shapes and objects.

Each of the panels or discs 10a through 10c is identical to the other discs, excepting the color of the translucent central panel and corresponding color of the handling rim. The various discs comprising a set of three colors may be formed in virtually any colors, tints, tones, densities, and/or gradients, as desired. However, for the purposes of teaching the effects of additive and subtractive colors, it is preferred that the panels or discs comprising any given set use the primary colors forming the additive or subtractive color series, as desired. For example, the translucent panels 12a through 12c of the three discs 10a through 10c are respectively colored or tinted with the three primary additive colors blue (as indicated by the color symbol inset in the central pane or sheet 12a of the panel 10a), green (the color symbol inset in the pane 12b of panel 10b) and red (the color symbol inset in the pane or sheet 12c of disc 10c) A single color is applied uniformly and homogeneously throughout the span of each sheet or pane 12a, 12b, and 12c. It should be noted that while any combination of additive and/or subtractive colors may be used in the present color teaching toy, the toy itself is used in the subtractive sense, i.e., with one or more of the translucent sheets being disposed between the object and the observer and used to filter out (subtract) one or more colors emitted or reflected from the object toward the observer. The rims 14a through 14c are identically colored to their respective central sheets or panes 12a through 12c to facilitate recognition, as noted further above.

FIG. 1 shows the method of use of the present toy in teaching the effects of various colors in the viewing of other objects, and the different colors resulting from different translucent panels. In FIG. 1, a child C1 holding up the overlapping color discs 10a (blue) and 10b (green) and viewing the yellow banana B therethrough, will see the banana B as a darker greenish hue, due to the little light reflected from the yellow banana which is in the proper portion of the spectrum to pass through the blue and green color filters 12a and 12b of the discs 10a and 10b. Combinations of different toy elements 10a through 10c and viewing differently colored objects therethrough will result in the perception of various different colors for the objects, depending upon the actual color of the object and the specific filters 12a through 12c used. Small children may also enjoy having one child hold a single disc, and getting together with another child to observe the resulting color when the two (or more) children overlap their respective discs.

As an aid to combining two or more of the discs 10a through 10c together, some means may be provided to facilitate securing the discs together loosely and limiting their movement relative to one another when stacked together. The handling rims 14a through 14c of the toy elements 10a through 10c of FIG. 2 are provided with a series of evenly spaced depressions 16 disposed upon one side of each of the rims 14a through 14c, and complementary, mating protrusions 1extending slightly from the opposite surfaces or sides of the rims 14a through 14c. The protrusions 18 and depressions 16 fit with one another to preclude lateral sliding of the discs 10a through 10c relative to one another when stacked or held together, but allow the discs to be separated from one another as desired without requiring any additional force or manipulation. Alternatively, the depressions 16 and protrusions 18 could be placed in an alternating array upon each surface, thus allowing the discs 10a through 10c to be assembled together regardless of their relative orientations.

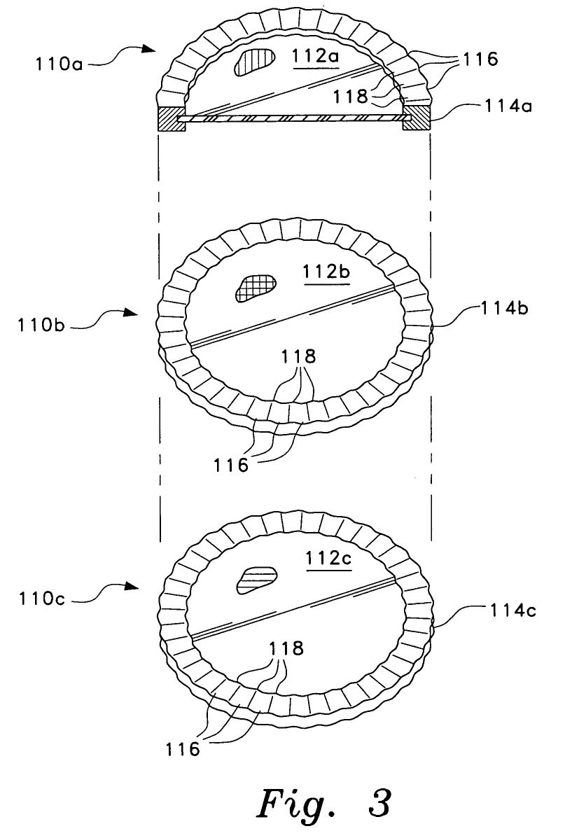

FIG. 3 is an illustration of a related embodiment comprising discs or panels 110a through 110c. The discs or panels 110a through 110c of FIG. 3 each comprise a relatively thin, flat, and unbroken central translucent sheet, respectively 112a through 112c, surrounded by a continuous, unbroken peripheral handling rim, respectively 114a through 114c, generally along the lines of the configurations of the first embodiment toy elements 10a through 10c of FIG. 2. The central translucent sheets or panes 112a through 112c of the embodiment of FIG. 3 differ from their respective counterparts 12a through 12c of the assembly of FIG. 2, in that the colors used are subtractive, e.g., cyan for the first panel 112a, yellow for the second panel 112b, and magenta for the third panel 112c. Combinations of any two of these subtractive colors result in one of the primary additive colors, with the assembly of all three discs 110a through 110c superimposed with one another resulting in the complete blocking of all light therethrough. An object viewed through the color teaching toy units 110a through 110c is perceived as having a color according to the combination of units 110a through 110c used.

The handling rims 114a through 114c of the units 110a through 110c differ from the rims 14a through 14c of the embodiment of FIG. 2, with the rims 114a through 114c having a non-circular cross section (e.g., square or rectangular). It should also be noted that while the central panels 112a through 112c are formed of translucent, tinted sheets of material, the corresponding rims 114a through 114c are formed separately as opaque structures. However, the rims 114a through 114c still completely surround their respective central translucent panels 112a through 112c in a continuous, unbroken ring, and are still of corresponding color (opaque, rather than translucent) to their respective panels 112a through 112c.

The handling rims 114a through 114c of the toy elements 110a through 110c of FIG. 3 also have a different means of loosely securing the devices to one another, than that disclosed in the assembly of FIG. 2. In FIG. 3, each of the rims 114a through 114c is provided with a series of complementary or mating radially disposed grooves 116 and ridges 118. As these grooves 116 and ridges 118 alternate with one another completely about the opposed surfaces of each of the rims 114a through 114c, any of the series of components 110a through 110c may be stacked or loosely assembled with any other component, in any orientation, so long as the rims 114a through 114c are congruent with one another. Alternatively, the rims of the units 110a through 110c may have the same configuration as the rims 14a through 14c of the toy elements 10a through 10c of FIG. 2, or those elements 10a through 10c may be provided with the rims 114a through 114c of the embodiment 10a through 10c, if so desired.

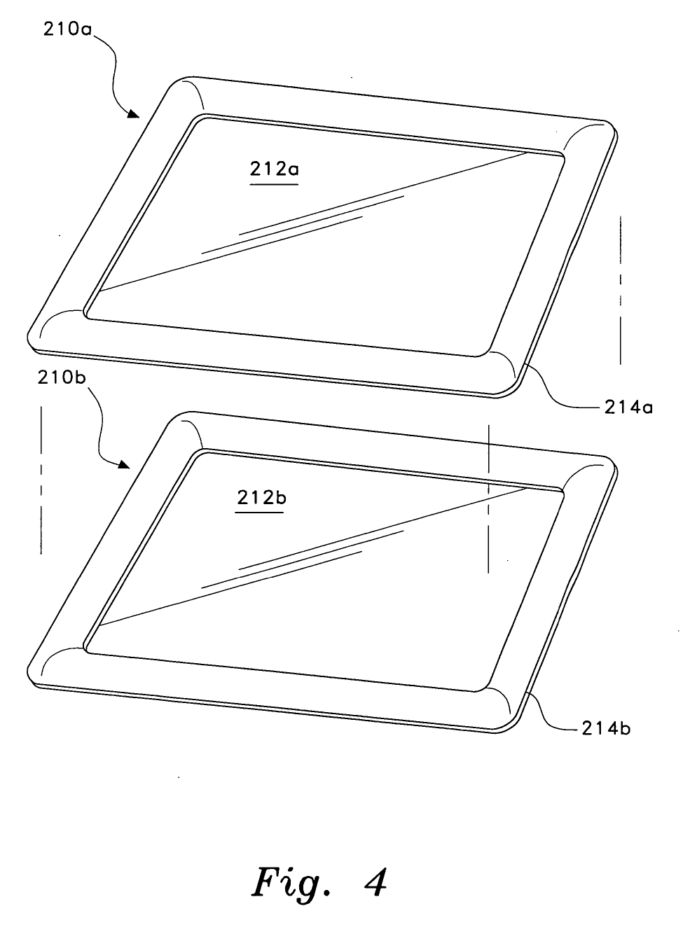

FIG. 4 provides an illustration of a pair of panels 210a and 210b comprising yet another embodiment of the present color teaching toy, in which the panels or toy elements 210a and 210b have square or rectangular shapes. While only two such panels 210a and 210b are shown in FIG. 4, it will be understood that a complete set would comprise three such panels each having different colors from one another, as in the embodiments of FIGS. 2 and 3. The panels 210a and 210b each comprise a relatively thin, flat, and unbroken central translucent sheet, respectively 212a and 212b, surrounded by a continuous, unbroken peripheral handling rim, respectively 214a and 214b. The rims 214a and 214b may be formed integrally with their translucent panels 212a and 212b, or as separate components, as desired, just as in the embodiments of FIGS. 2 and 3 discussed further above. The rims 214a, 214b may be devoid of any means for loosely securing the elements 210a, 210b together (e.g., protrusions and depressions, ridges and grooves, etc.), or may be provided with such, as shown in FIGS. 2 and 3. The translucent sheets or panes 212a and 212b may be colored in any primary or secondary additive or subtractive colors, as desired, so long as the colors of the set are different from one another in each element in order to provide the desired effect.

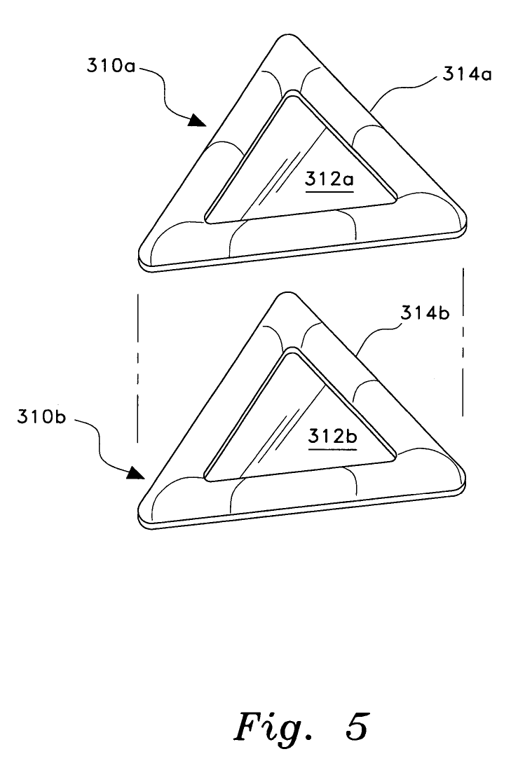

FIG. 5 illustrates still another embodiment of the present invention, wherein the panels 310a and 310b (only two of the three comprising a set are shown in FIG. 5) each have a triangular configuration. As in the other embodiments described herein, the panels 310a and 310b each comprise a relatively thin, flat, and unbroken central translucent sheet, respectively 312a and 312b, surrounded by a continuous, unbroken peripheral handling rim, respectively 314a and 314b. The rims 314a and 314b may be formed integrally with their translucent panels 312a and 312b, or as separate components, as desired, just as in the embodiments of FIGS. 2 and 3 discussed further above. The rims 314a, 314b may be devoid of any means for loosely securing the elements 310a, 310b together (e.g., protrusions and depressions, ridges and grooves, etc.), or may be provided with such, as shown in FIGS. 2 and 3. The translucent sheets or panes 312a and 312b may be colored in any primary or secondary additive or subtractive colors, as desired, so long as the colors of the set are different from one another in each element in order to provide the desired effect. It will be seen that the elements of the color teaching toy may be formed to have virtually any regular plane geometric configuration as desired, e.g., circular, oval, elliptical, polygonal, etc., as desired. Alternatively, irregular shapes of various configurations may be formed, as desired.

In conclusion, the present toy for teaching colors in its various embodiments provides an economical yet sound means of demonstrating the effects of various additive and subtractive colors in the perception of the color of various objects. Moreover, the present toy teaches the resulting color when various colors are combined with one another, e.g., red and blue to produce purple, etc. The demonstration of the effects of such colors on the perception of objects and their colors not only provides an effective means of teaching the color spectrum, but also emphasizes the point that only the perception of the object changes with color changes, with the object per se remaining the same. This can be an important point in teaching the concept that people of all colors and races are equal, and that the exterior color, whether it be of an object or of a person, is but a superficial consideration. Accordingly, the present toy for teaching color will prove to be a most valuable teaching tool in virtually any school system or other learning environment.

It is to be understood that the present invention is not limited to the embodiments described above, but encompasses any and all embodiments within the scope of the following claims.

I claim:

1. A toy kit for teaching colors, comprising:
a first panel, a second panel, and a third panel, each comprising a thin, flat, unbroken, translucent sheet of material and each having a different primary subtractive color from one another applied homogeneously and uniformly thereto; and
a peripheral handling rim of like color to each said panel, completely surrounding each respective said panel as a continuous, unbroken band.

2. The toy kit for teaching colors according to claim 1, further including complementary mating engagement depressions and protrusions disposed upon each said handling rim.

3. The toy kit for teaching colors according to claim 2, wherein the engagement depressions and protrusions are selected from the group consisting of mating recesses and knobs, and mating radially disposed grooves and ridges.

4. The toy kit for teaching colors according to claim 1, wherein each said panel and each said handling rim is formed of a stiff plastic material.

5. The toy kit for teaching colors according to claim 1, wherein each said panel and each respective said handling rim is formed as an integral and monolithic unit with one another.

6. The toy kit for teaching colors according to claim 1, wherein said handling rim of each said panel is of an opaque color matching the translucent color of the corresponding said panel.

7. The toy kit for teaching colors according to claim 1, wherein each said panel and each said handling rim has a regular geometric shape.

8. A method of teaching colors using the toy kit of claim 1, comprising the steps of:
(a) providing a series of the panels to at least one student;
(b) transposing at least one of the panels between the eyes of the student and a selected object; and
(c) noting an apparent change in color of the object when viewed through the at least one panel transposed therebetween.

9. The method of claim 8, further including the steps of:
(a) transposing two superimposed panels between the eyes of the student and the selected object; and
(b) noting a different third color produced by the two colors of the two panels when superimposed with one another.

10. A toy kit for teaching colors, comprising:
a first panel, a second panel, and a third panel, each comprising a thin, flat, unbroken, translucent sheet of material and each having a different primary additive color from one another applied homogeneously and uniformly thereto; and
a peripheral handling rim of like color to each said panel, completely surrounding each respective said panel as a continuous, unbroken band.

11. The toy kit for teaching colors according to claim 10, further including complementary mating engagement depressions and protrusions disposed upon each said handling rim.

12. The toy kit for teaching colors according to claim 11, wherein the engagement depressions and protrusions are selected from the group consisting of mating recesses and knobs, and mating radially disposed grooves and ridges.

13. The toy kit for teaching colors according to claim 10, wherein each said panel and each said handling rim is formed of a stiff plastic material.

14. The toy kit for teaching colors according to claim 10, wherein each said panel and each respective said handling rim is formed as an integral and monolithic unit with one another.

15. The toy kit for teaching colors according to claim 10, wherein the handling rim of each said panel is of an opaque color matching the translucent color of the corresponding said panel.

16. The toy kit for teaching colors according to claim 10, wherein each said panel and each said handling rim has a regular geometric shape.

17. A method of teaching colors using the toy of claim 10, comprising the steps of:
(a) providing a series of the panels to at least one student;
(b) transposing at least one panel between the eyes of the student and a selected object; and
(c) noting an apparent change in color of the object when viewed through the at least one panel transposed therebetween.

18. The method of claim 17, further including the steps of:
(a) transposing two superimposed panels between the eyes of the student and the selected object; and
(b) noting a different third color produced by the two colors of the two panels when superimposed with one another. 22
